(19) United States
(12) Patent Application Publication
(10) Pub. No.: US 2016/0148381 A1
(43) Pub. Date: May 26, 2016

(54) OBJECT RECOGNITION DEVICE AND OBJECT RECOGNITION METHOD

(71) Applicant: PANASONIC INTELLECTUAL PROPERTY MANAGEMENT CO., LTD., Osaka-shi, Osaka (JP)

(72) Inventors: Katsuji AOKI, Kanagawa (JP); Hajime TAMURA, Tokyo (JP); Takayuki MATSUKAWA, Kanagawa (JP); Shin YAMADA, Kanagawa (JP); Hiroaki YOSHIO, Kanagawa (JP)

(73) Assignee: PANASONIC INTELLECTUAL PROPERTY MANAGEMENT CO., LTD., Osaka (JP)

(21) Appl. No.: 14/898,847

(22) PCT Filed: Jun. 30, 2014
(86) PCT No.: PCT/JP2014/003480

§ 371 Date: Dec. 16, 2015

(30) Foreign Application Priority Data
Jul. 3, 2013 (JP) 2013-139945

(51) Int. Cl. G06T 7/00; G06K 9/00; G06K 9/62

(52) U.S. Cl. CPC G06T 7/0028; G06K 9/6267; G06T 7/0042; G06K 9/00255; G06K 9/00288; G06K 9/00268; G06T 2207/10016; G06T 2207/30201

(57) ABSTRACT

A category selection portion selects a face orientation based on an error between the positions of feature points (the eyes and the mouth) on the faces of each face orientation and the positions of feature points, corresponding to the feature points on the faces of each category, on the face of a collation face image. A collation portion collates the registered face images of the face orientation selected by the category selection portion and the collation face image with each other, and the face orientations are determined so that face orientation ranges where the error with respect to each individual face orientation is within a predetermined value are in contact with each other or overlap each other. The collation face image and the registered face images can be more accurately collated with each other.

### TECHNICAL FIELD

The present disclosure relates to an object recognition device and an object recognition method suitable for use in a surveillance camera.

### BACKGROUND ART

An object recognition method has been devised where an image of a photographed object (for example, a face, a person or a vehicle) (called a taken image) and an estimated object image that is in the same positional relationship (for example, the orientation) as this taken image and is generated from an image of an object to be recognized are collated with each other. As an object recognition method of this kind, for example, a face image recognition method described in Patent Document 1 is available. According to the face image recognition method described in Patent Document 1, a viewpoint taken face image that is taken according to a given viewpoint is inputted, a wireframe is allocated to a frontal face image of a preregistered person to be recognized, a deformation parameter corresponding to each of a plurality of viewpoints including the given viewpoint is applied to the wireframe-allocated frontal face image to thereby change the frontal face image to a plurality of estimated face images estimated to be taken according to the plurality of viewpoints and register them, the face image of each viewpoint of the plurality of viewpoints is preregistered as viewpoint identification data, the viewpoint taken face image and the registered viewpoint identification data are collated with each other and the average of the collation scores is obtained for each viewpoint, an estimated face image of a viewpoint the average value of the collation scores of which is high is selected from among the registered estimated face images, and the viewpoint taken face image and the selected estimated face image are collated with each other to thereby identify the person of the viewpoint taken face image.

### PRIOR ART DOCUMENT

### Patent Document

Patent Document 1: JP-A-2003-263639

### SUMMARY OF THE INVENTION

### Problem that the Invention is to Solve

However, according to the above-described face image recognition method described in Patent Document 1, although collation between the estimated face image and the taken image is performed for each positional relationship (for example, the face orientation), since the positional relationships are merely broadly categorized such as the left, the right, the upside, . . . , a problem arises in that accurate collation cannot be performed. In the present description, the taken image is called a collation object image including a collation face image, and the estimated face image is called a registered object image including a registered face image.

The present disclosure is made in view of such circumstances, and an object thereof is to provide an object recognition device and an object recognition method capable of more accurately collating the collation object image and the registered object image.

### Means for Solving the Problem

An object recognition device of the present disclosure has: a selection portion that selects a specific object orientation based on an error between positions of feature points on objects of registered object images which are registered and categorized by object orientation and a position of a feature point, corresponding to the feature point, on an object of a collation object image; and a collation portion that collates the registered object images belonging to the selected object orientation and the collation object image with each other, the registered object images are each categorized by object orientation range, and the object orientation range is determined based on the feature point.

### Advantage of the Invention

According to the present disclosure, the collation object image and the registered object image can be more accurately collated with each other.

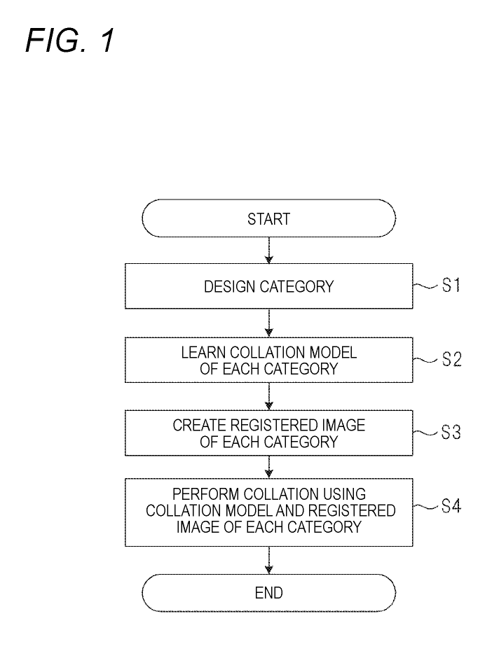

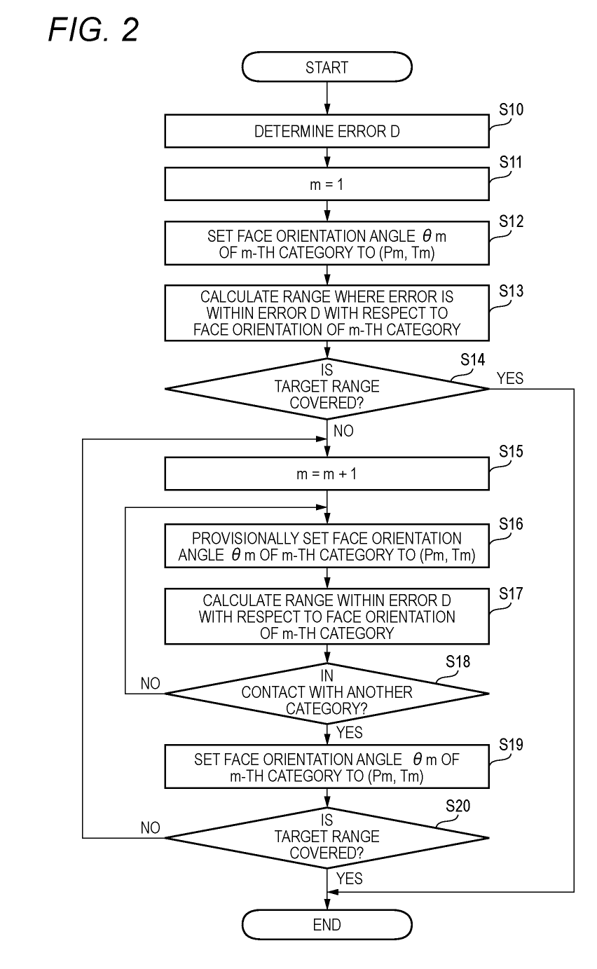

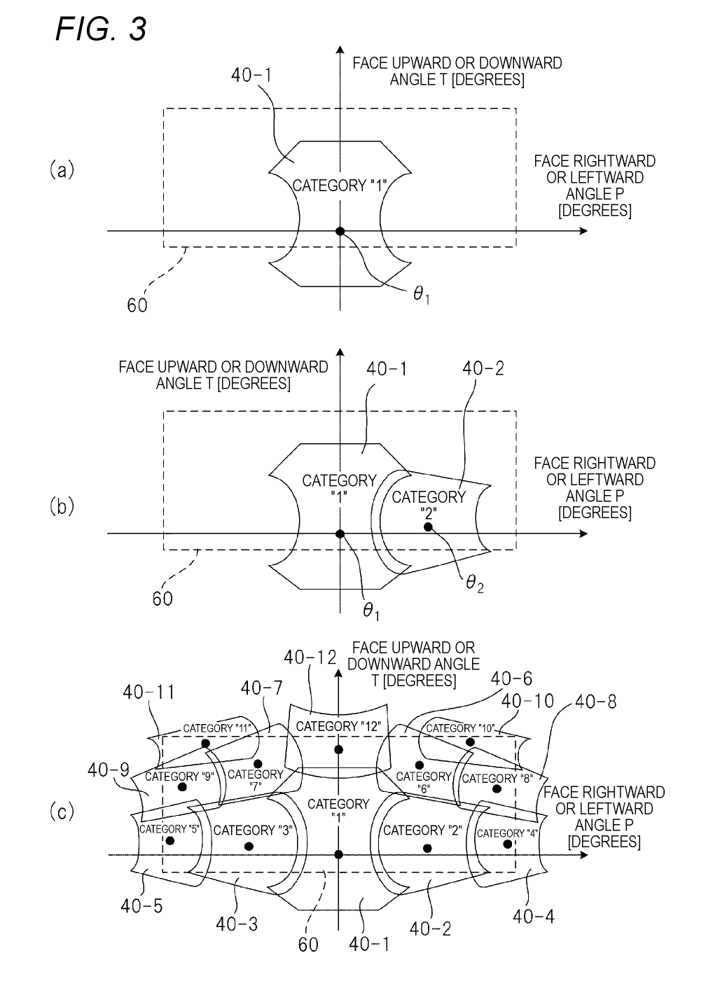

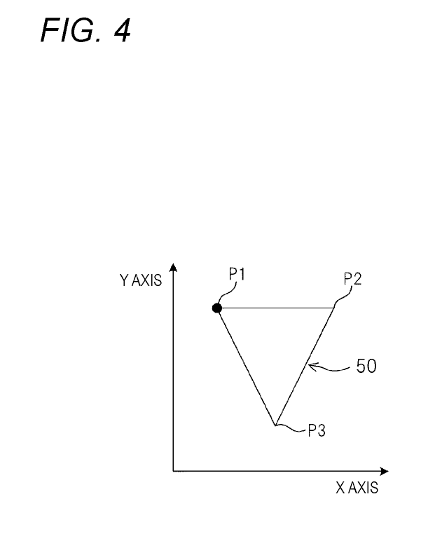

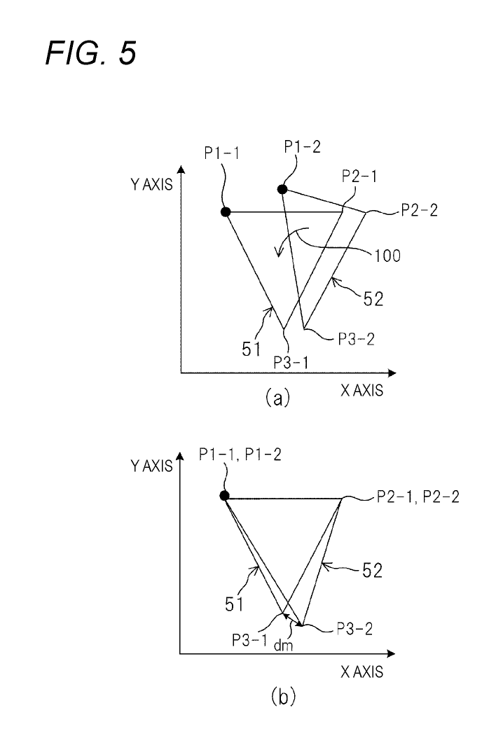

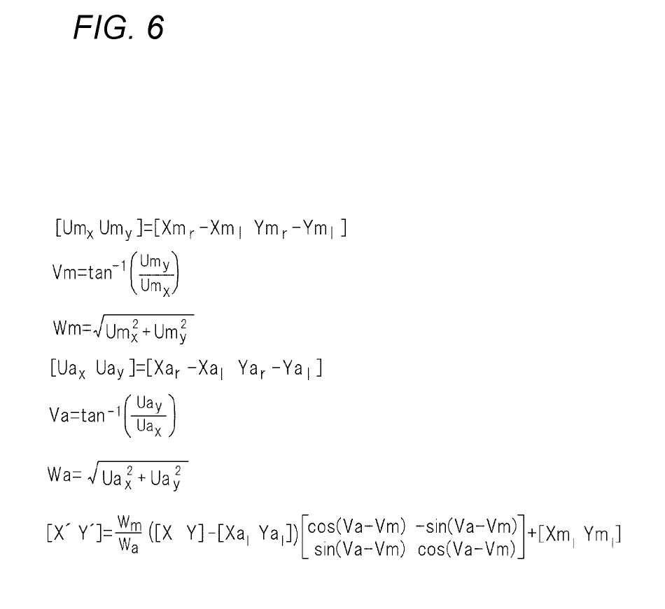

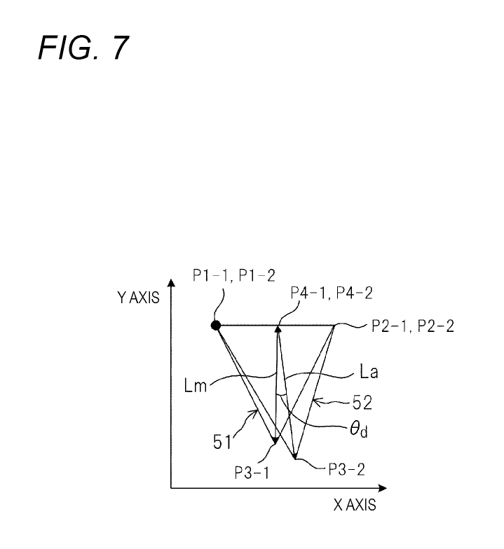

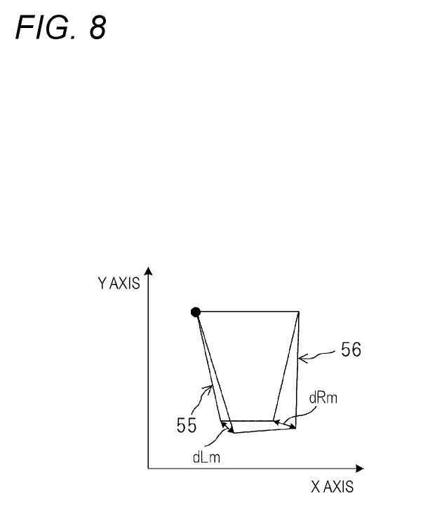

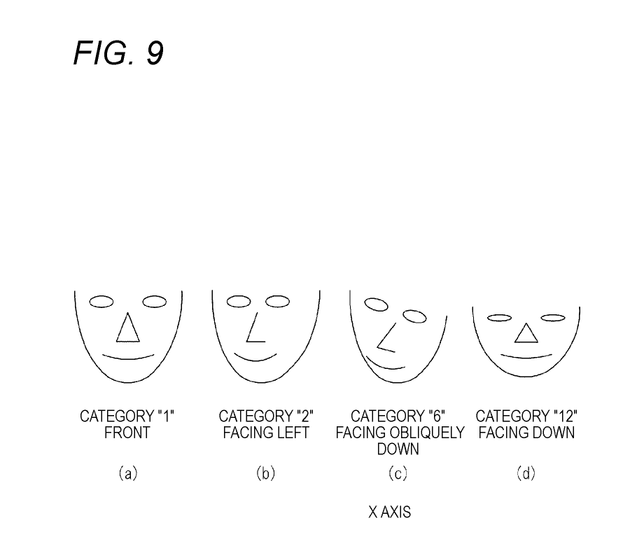

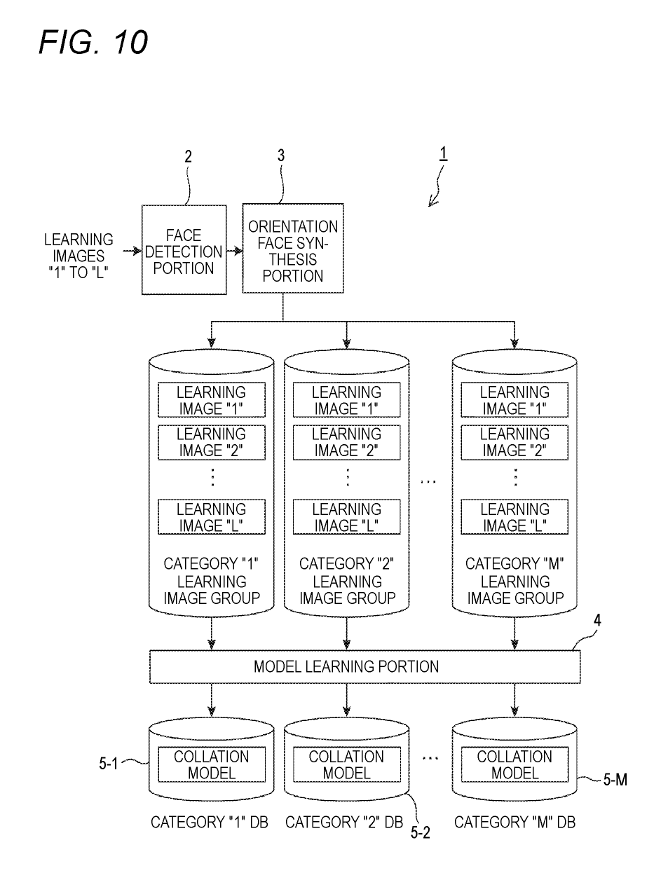

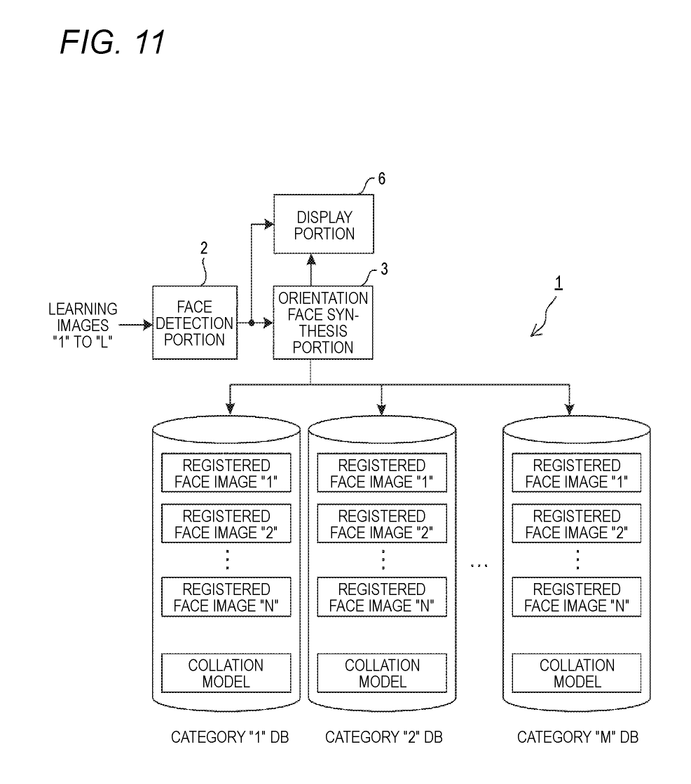

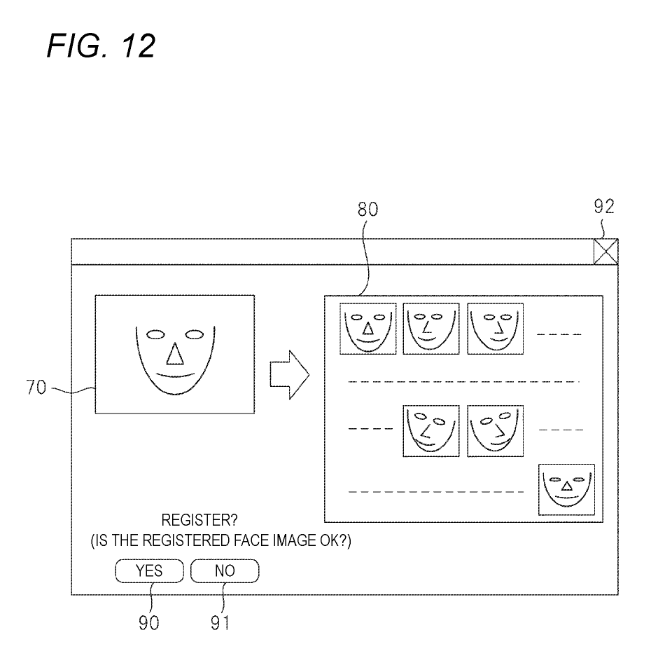

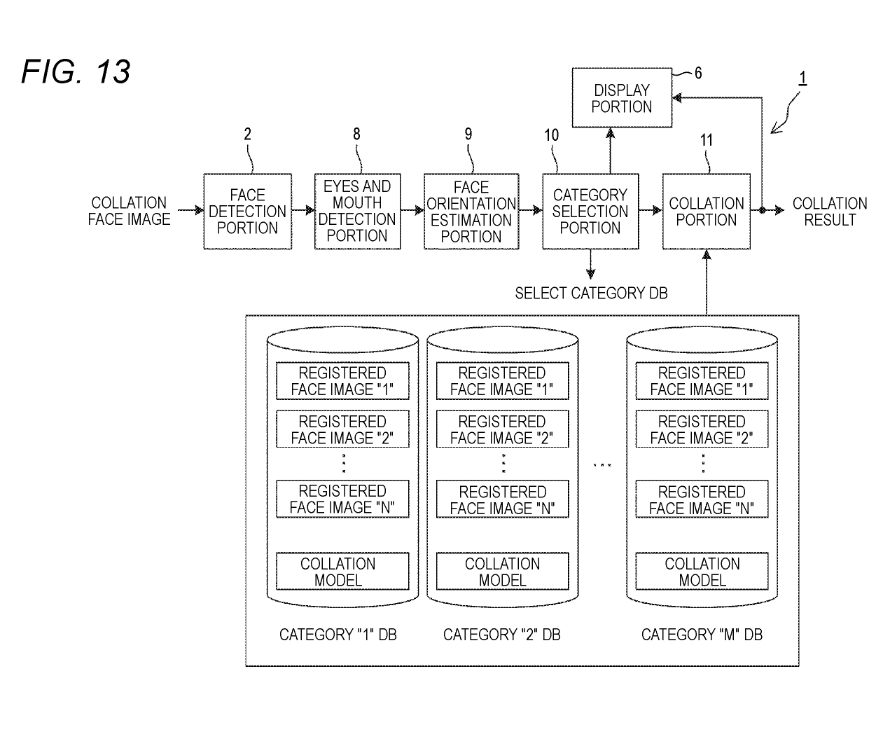

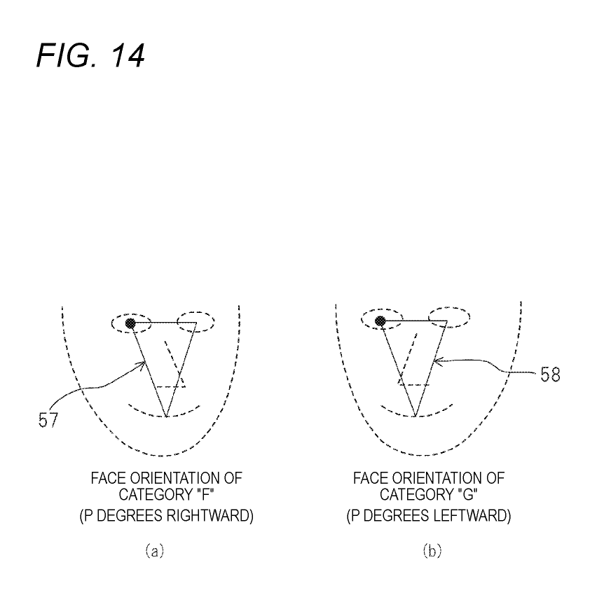

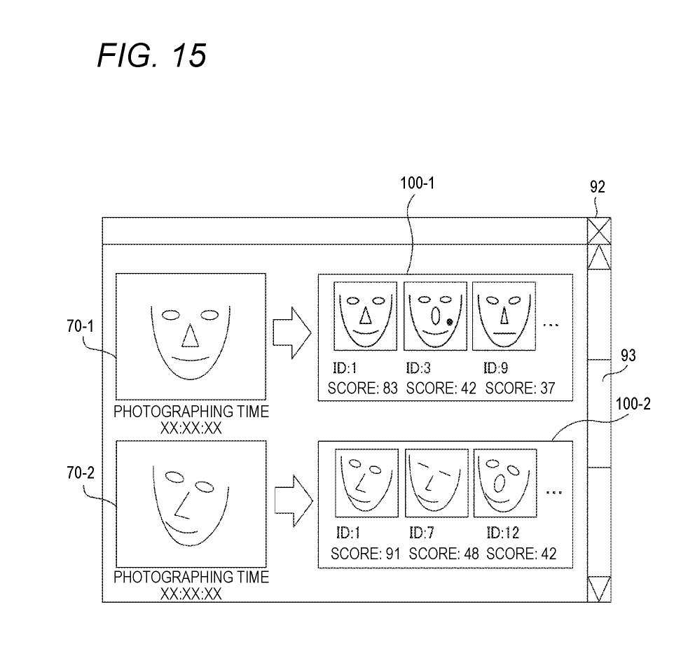

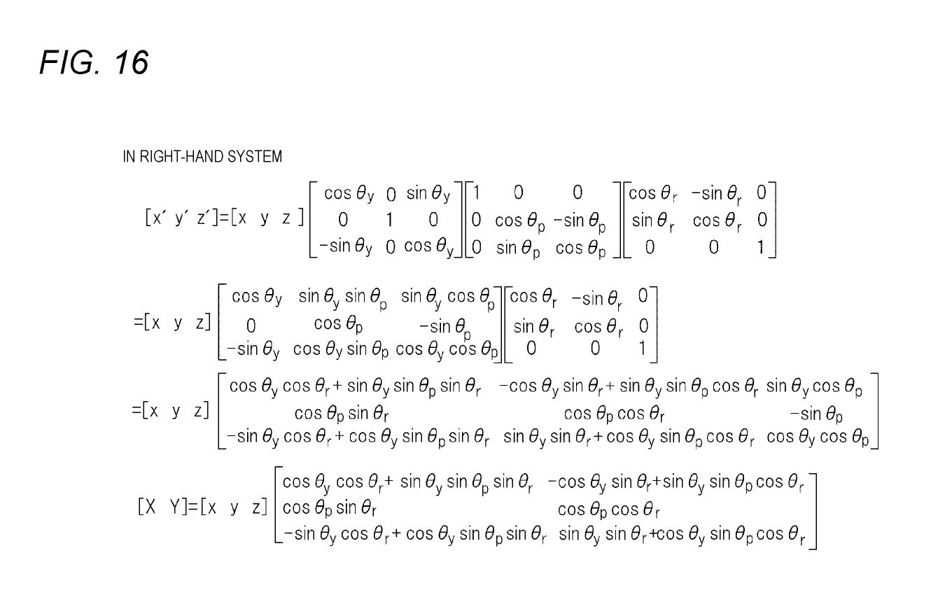

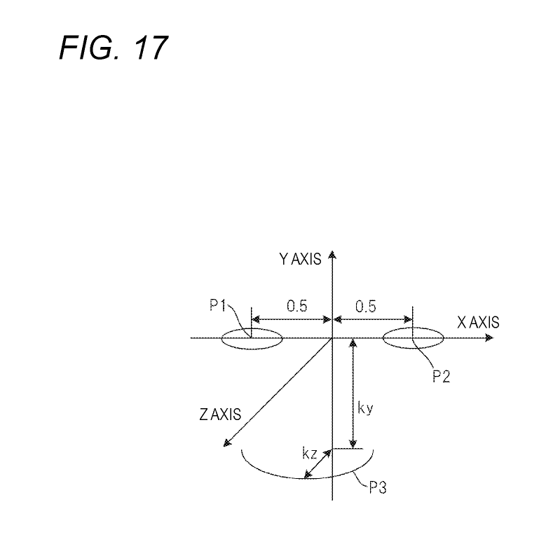

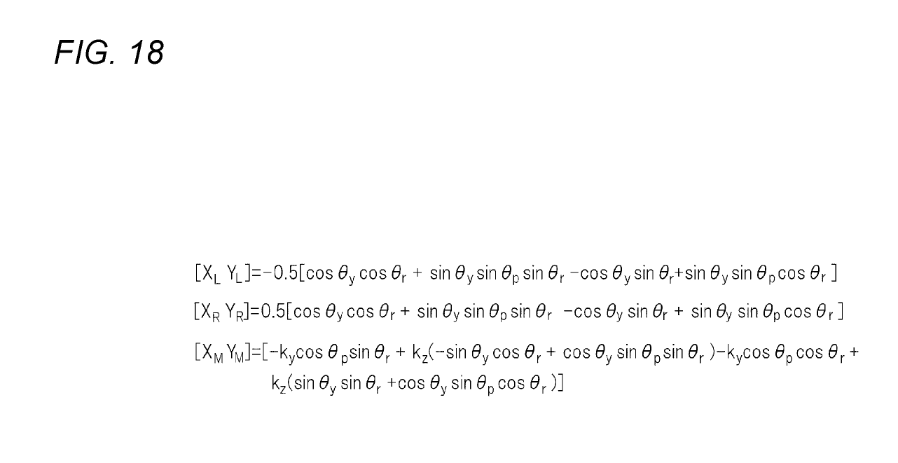

### BRIEF DESCRIPTION OF THE DRAWINGS

[FIG. 1] A flowchart showing the flow of the processing from category design to collation of an object recognition device according to an embodiment of the present disclosure.

[FIG. 2] A flowchart showing the detailed flow of the category design of FIG. 1.

[FIG. 3] (a) to (c) Views for explaining the category design of FIG. 2.

[FIG. 4] A view showing the positions, on a two-dimensional plane, of facial feature elements (the eyes and the mouth) in the category design of FIG. 2.

[FIG. 5] (a), (b) Views for explaining a method for calculating the error of the facial feature elements (the eyes and the mouth) between the face orientation of a category m in the category design of FIG. 2 and a face orientation θa.

[FIG. 6] A view showing an affine transformation expression used for the category design of FIG. 2.

[FIG. 7] A view for explaining a definition example (2) of an error d of the facial feature elements in the category design of FIG. 2.

[FIG. 8] A view for explaining a definition example (3) of the error d of the facial feature elements in the category design of FIG. 2.

[FIG. 9] (a) to (d) Views showing an example of face orientations of categories in the category design of FIG. 2.

[FIG. 10] A block diagram showing a collation model learning function of the object recognition device according to the present embodiment.

[FIG. 11] A block diagram showing a registered image creation function of the object recognition device according to the present embodiment.

[FIG. 12] A view showing an example of the operation screen by the registered image creation function of FIG. 11.

[FIG. 13] A block diagram showing a collation function of the object recognition device according to the present embodiment.

[FIG. 14] (a), (b) Views for explaining the reason why the face orientation estimation is necessary at the time of the collation.

[FIG. 15] A view showing an example of the presentation screen of the result of the collation by the collation function of FIG. 13.

[FIG. 16] A view showing a commonly-used expression to project three-dimensional positions to positions on a two-dimensional plane (image).

[FIG. 17] A view showing an example of the eyes and mouth positions on a three-dimensional space.

[FIG. 18] A view showing an expression to calculate the two-dimensional eyes and mouth positions.

### MODE FOR CARRYING OUT THE INVENTION

Hereinafter, a preferred embodiment for carrying out the present disclosure will be described in detail with reference to the drawings.

FIG. 1 is a flowchart showing the flow of the processing from category design to collation of an object recognition device according to an embodiment of the present disclosure. In the figure, the object recognition device according to the present embodiment is formed of four processings of the processing of category design (step S1), the processing of learning the collation model of each category (step S2), the processing of creating the registered image of each category (step S3) and the processing of collation using the collation model and the registered image of each category (step S4). Hereinafter, the processings will be described in detail.

FIG. 2 is a flowchart showing the detailed flow of the category design of FIG. 1. Moreover, (a) to (C) of FIG. 3 are views for explaining the category design of FIG. 2. While a human face image is handled as the object image in the present embodiment, it is merely an example, and an image other than a human face image can be handled without any problem.

In FIG. 2, first, a predetermined error D is determined (step S10). That is, the error D between a face image of a photographed person (corresponding to the collation object image and called “collation face image”) and a registered face image (corresponding to the “registered object image”) for collation with this collation face image is determined. Details of the determination of the error D will be described. FIG. 4 is a view showing the positions, on a two-dimensional plane, of facial feature elements (the eyes and the mouth) in the category design of FIG. 2. In the figure, the eyes and the mouth are shown by a triangle 50, the vertex P1 is the left eye position, the vertex P2 is the right eye position, and the vertex P3 is the mouth position. In this case, the vertex P1 indicating the left eye position is shown by a black circle, and with this black circle as the starting point, the vertices P1, P2 and P3 indicating the left eye, the right eye and the mouth position exist in the clockwise direction.

Since the face is a three-dimensional object, the positions of the facial feature elements (the eyes and the mouth) are also three-dimensional positions, and a method for converting the three-dimensional positions into two-dimensional positions like the vertices P1, P2 and P3 will be described below.

FIG. 16 is a view showing a commonly-used expression to project three-dimensional positions to positions on a two-dimensional plane (image). Here, in the expression,

θy: the yaw angle (horizontal angle)

θp: the pitch angle (vertical angle)

θr: the roll angle (rotation angle)

[x y z]: the three-dimensional positions

[X Y]: the two-dimensional positions

FIG. 17 is a view showing an example of the eyes and mouth positions on the three-dimensional space. The eyes and mouth positions shown in the figure are as follows:

the left eye: [x y z]=[−0.5 0 0]

the right eye: [x y z]=[0.5 0 0]

the mouth: [x y z]=[0 −ky kz]

(ky and kz are coefficients.)

By substituting the above eyes and mouth positions on the three-dimensional space into the expression to project the three-dimensional positions onto the positions on the two-dimensional plane shown in FIG. 16, the eyes and mouth positions, on the two-dimensional plane, in each face orientation (θy: the yaw angle, θp: the pitch angle and θr: the roll angle) are calculated by the expression shown in FIG. 18:

[X_{L} Y_{L}]: the left eye position P1

[X_{R} Y_{R}]: the right eye position P2

[X_{M} Y_{M}]: the mouth position P3

(a) and (b) of FIG. 5 are views for explaining the method for calculating the error of the facial feature elements (the eyes and the mouth) between the face orientation of the category m in the category design of FIG. 2 and the face orientation θa. (a) of the figure shows a triangle 51 showing the eyes and mouth positions of the face orientation of the category m and a triangle 52 showing the eyes and mouth positions of the face orientation θa. Moreover, (b) of the figure shows a condition where the positions of the eyes of the triangle 52 indicating the eyes and mouth positions of the face orientation θa are superposed on the positions of the eyes of the face orientation of the category m. The face orientation θa is, at the time of the category design, the face orientation of the face used for determining whether the error is within the error D or not, and is, at the time of the collation, the face orientation of the face of the collation face image. The positions of the right and left eyes of the face orientation θa are superposed on the positions of the right and left eyes of the face orientation of the category m, and an affine transformation expression is used for this processing. By using the affine transformation expression, as shown by the arrow 100 in (a) of FIG. 5, rotation, scaling and translation on the two-dimensional plane are performed on the triangle 52.

FIG. 6 is a view showing the affine transformation expression used for the category design of FIG. 2. Here, in the expression,

[Xmₗ Ymₗ]: the left eye position of the category m

[Xmᵣ Ymᵣ]: the right eye position of the category m

[Xaₗ Yaₗ]: the left eye position of the face orientation θa

[Xaₐ Yap]: the right eye position of the face orientation θa

[X Y]: the position before the affine transformation

[X′ Y′]: the position after the affine transformation

By using this affine transformation expression, the positions, after the affine transformation, of the three points (the left eye, the right eye and the mouth) of the face orientation θa are calculated. The left eye position of the face orientation θa after the affine transformation coincides with the left eye position of the category m, and the right eye position of the face orientation θa coincides with the right eye position of the category m.

In (b) of FIG. 5, under a condition where the processing of superposing the positions of the eyes of the face orientation θa on the positions of the eyes of the face orientation of the category m by using the affine transformation expression has been performed and the positions thereof coincide with each other, the distance difference between the mouth positions as the remaining one points is set as the error of the facial feature elements. That is, the distance dm between the mouth position P3-1 of the face orientation of the category m and the mouth position P3-2 of the face orientation θa is set as the error of the facial feature elements.

Returning to FIG. 2, after the error D is determined, the value of a counter m is set to “1” (step S11), and the face orientation angle θm of the m-th category is set to (Pm, Tm) (step S12). Then, with respect to the face orientation of the m-th category, the range where the error is within the predetermined error D is calculated (step S13). In the category m, the range within the error D is a range of the face orientation θa where when the positions of the eyes of the face orientation of the category m and the positions of the eyes of the face orientation θa are superposed on each other, the distance error dm between the mouth positions is within the error D. By performing affine transformation so that the positions of the eyes as two points of the facial feature elements are the same positions, the difference (that is, the difference dm) between the mouth positions as the remaining one points becomes within the error D; therefore, by superposing the positions of the eyes on each other and making the difference between the mouth positions within the error D, more accurate collation is possible in the collation between the collation face image and the registered face image (the reason is that the more the positional relationships among the facial feature elements are the same, the more excellent, the collation performance is). Moreover, at the time of the collation between the collation face image and the registered face image, collation performance is improved by selecting a category within the error D from the eyes and mouth positions of the face of the collation face image and the estimated face orientation.

While the above described is a definition example (1) of the error d of the facial feature elements, other definition examples will also be described.

FIG. 7 is a view for explaining a definition example (2) of the error d of the facial feature elements in the category design of FIG. 2. In the figure, a line segment Lm from the midpoint P4-1 between the left eye position and the right eye position to the mouth position P3-1 of the triangle 51 of the face orientation of the category m is taken, and a line segment La from the midpoint P4-2 between the left eye position and the right eye position to the mouth position P3-2 of the triangle 52 of the face orientation θa is taken. Then, the error d of the facial feature elements is defined by two elements of the angle difference θd between the line segment Lm of the face orientation of the category m and the line segment La of the face orientation θa and the difference |Lm−La| in length between the line segments Lm and La of both. That is, the error d of the facial feature elements is set to [θd|Lm−La|]. In the case of this definition, the range within the error D is within the angle difference θ_{D} and the length difference L_{D}.

Next, a definition example (3) of the error d of the facial feature elements will be described. The definition example (3) of the error d of the facial feature elements is a definition of the error d of the facial feature elements when the facial feature elements are four points (the left eye, the right eye, the left mouth end and the right mouth end). FIG. 8 is a view for explaining the definition example (3) of the error d of the facial feature elements in the category design of FIG. 2. In the figure, a quadrangle 55 is set that shows the positions of the eyes and mouth ends of the face orientation of the category m, and a quadrangle 56 is set that shows the positions of the eyes and mouth ends of the face orientation θa where the positions of the eyes of the face orientation of the category m and the positions of the eyes of the face orientation θa are superposed on each other. The error d of the facial feature elements is defined by the distance dLm between the left mouth end position of the face orientation of the category m and the left mouth end position of the face orientation θa and the distance dRm between the right mouth end position of the face orientation of the category m and the right mouth end position of the face orientation θa. That is, the error d of the facial feature elements is set to [dLm, dRm]. In the case of this definition, the range within the error D is where dLm<=D and dRm<=D or the average value of dLm and dRm is within D.

As described above, under a condition where the positions of two points (the left eye and the right eye) are superposed on each other similarly to three points (the left eye, the right eye and the mouth), the distances between the remaining two points (the left mouth end and the right mouth end) of both (the face orientation of the category m and the face orientation θa) are set as the error d of the facial feature elements. The error d may be the two elements of the distance dLm between the left mouth end positions and the distance dRm between the right mouth end positions, or may be one element of the sum of the distance dLm and the distance dRm or the larger one of the distance dLm and the distance dRm. Further, it may be the angle difference and the line segment length difference between the two points as shown in FIG. 7 in the above-described definition example (2).

Moreover, while examples of the definition example (1) where the facial feature elements are three points and the definition example (3) where the facial feature elements are four points are shown, when the number of facial feature elements is N (N is an integer not less than three) points, it is similarly possible to superpose the two points on each other, define the error of the facial feature elements by the distance difference or the angle difference and the line segment length difference between the remaining N−2 points and calculate the error.

Returning to FIG. 2, after the range within the error D is calculated at step S13, it is determined whether the range within the error D covers (fills) a target range or not (step S14). Here, the target range is an assumed range of the orientation of the collation face image inputted at the time of the collation. The assumed range is set as the target range at the time of the category design so that collation can be performed within the assumed range of the orientation of the collation face image (that is, so that excellent collation performance is obtained). The range shown by the rectangular broken line in (a) to (c) of FIG. 3 is the target range 60. When it is determined at the determination of step S14 that the range calculated at step S13 covers the target range (that is, the determination result is “Yes”), the present processing is ended. When the target range is covered is when the condition as shown in (c) of FIG. 3 is reached. On the contrary, when the target range is not covered (that is, the determination result is “No”), the value of the counter m is incremented by “1” and set to m=m+1 (step S15), and the face orientation angle θm of the m-th category is provisionally set to (Pm, Tm) (step S16). Then, with respect to the face orientation of the m-th category, the range where the error as the mouth shift is within the error D is calculated (step S17).

Then, it is determined whether the category is in contact with another category or not (step S18), and when it is in contact with no other categories (that is, the determination result is “No”), the process returns to step S16. On the contrary, when it is in contact with another category (that is, the determination result is “Yes”), the face orientation angle θm of the m-th category is set to (Pm, Tm) (step S19). That is, at steps S16 to S19, the face orientation angle θm of the m-th category is provisionally set, the range within the error D at the angle θm is calculated, and the face orientation angle θm of the m-th category is set while it is confirmed that the range is in contact with or overlaps the range within the error D of another category (the category “1” in (b) of FIG. 3).

After the face orientation angle θm of the m-th category is set to (Pm, Tm), it is determined whether the target range is covered or not (step S20), when the target range is covered (that is, the determination result is “Yes”), the present processing is ended, and when the target range is not covered (that is, the determination result is “No”), the process returns to step S15 to perform the processing of step S15 to step S19 until the target range is covered. When the target range is covered (filled without any space left) by the ranges within the error D of the categories by repeating the processing of step S15 to step S19, the category design is ended.

(a) of FIG. 3 shows a range 40-1 within the error D with respect to the face orientation θ₁ of the category “1”, and (b) of FIG. 3 shows a range 40-2 within the error D with respect to the face orientation θ₂ of the category “2”. The range 40-2 within the error D with respect to the face orientation θ₂ of the category “2” overlaps the range 40-1 within the error D with respect to the face orientation θ₁ of the category “1”. (c) of FIG. 3 shows ranges 40-1 to 40-12 within the error D with respect to the face orientations θ₁ to θ₁₂ of the categories “1” to “12”, respectively, and the target range 60 is covered (filled without any space left).

(a) to (d) of FIG. 9 are views showing an example of face orientations of categories in the category design of FIG. 2. The category “1” shown in (a) of the figure is the front, the category “2” shown in (b) is facing left, the category “6” shown in (c) is facing obliquely down, and the category “12” shown in (d) is facing down.

After the category design is performed as described above, at step S2 of FIG. 1, learning of the collation model of each category is performed. FIG. 10 is a block diagram showing a collation model learning function of an object recognition device 1 according to the present embodiment. In the figure, a face detection portion 2 detects faces from learning images “1” to “L”. An orientation face synthesis portion 3 creates a synthetic image of each category (the face orientation θm, m=1 to M) with respect to the face images of the learning images “1” to “L”. A model learning portion 4 learns the collation model for each of the categories “1” to “M” by using the learning image group of the category. The collation model learned by using the learning image group of the category “1” is stored in a database 5-1 of the category “1”. Likewise, the collation models learned by using the learning image groups of the categories “2” to “M” are stored in a database 5-2 of the category “2”, . . . and a database 5-M of the category “M”, respectively (“DB” stands for database).

After the processing of learning the collation model of each category is performed, creation of the registered face image of each category is performed at step S3 of FIG. 1. FIG. 11 is a block diagram showing a registered image creation function of the object recognition device 1 according to the present embodiment. In the figure, the face detection portion 2 detects faces from input images “1” to “N”. The orientation face synthesis portion 3 creates a synthetic image of each category (the face orientation θm, m=1 to M) with respect to the face images detected by the face detection portion 2, that is, the registered face images “1” to “N”. As the processing of the orientation face synthesis portion 3, for example, the processing described in “Real-Time Combined 2D+3D Active Appearance Models', Jing Xiao, Simon Baker, lain Matthews and Takeo Kanade, The Robotics Institute, Carnegie Mellon University, Pittsburgh, Pa. 15213” is suitable. For each of the categories “1” to “M”, the registered face images “1” to “N” of the category (the face orientation θm) are generated (that is, the registered face images are generated for each category). A display portion 6 visually displays the face image detected by the face detection portion 2, or visually displays the synthetic image created by the orientation face synthesis portion 3.

FIG. 12 is a view showing an example of the operation screen by the registered image creation function of FIG. 11. The operation screen shown in the figure is displayed as a confirmation screen at the time of the registered image creation. With respect to an inputted input image 70, a synthetic image of each category (the face orientation θm, m=1 to M) is created, and the created synthetic image is set as the registered face image (ID:1 in the FIG. 80 of each category. When a “YES” button 90 is pressed here, the synthetic image is registered, and when a “NO” button 91 is pressed, registration of the synthetic image is not performed. On the operation screen shown in FIG. 12, a close button 92 for closing this screen is set.

After the processing of creating the registered face image of each category is performed, at step S4 of FIG. 1, collation processing using the collation model and the registered face image of each category is performed. FIG. 13 is a block diagram showing a collation function of the object recognition device 1 according to the present embodiment. In the figure, the face detection portion 2 detects a face from the inputted registered image. An eyes and mouth detection portion 8 detects the eyes and the mouth from the face image detected by the face detection portion 2. A face orientation estimation portion 9 estimates the face orientation from the face image. As the processing of the face orientation estimation portion 9, for example, the processing described in “‘Head Pose Estimation in Computer Vision: A Survey’, Erik Murphy-Chutorian, Student Member, IEEE, and Mohan Manubhai Trivedi, Fellow, IEEE, IEEE TRANSACTIONS ON PATTERN ANALYSIS AND MACHINE INTELLIGENCE, VOL. 31, NO. 4, APRIL 2009” is suitable. A category selection portion (selection portion) 10 selects a specific face orientation based on the error between the positions of the feature points (the eyes and the mouth) on the faces of, of a plurality of registered face images registered being categorized by face orientation, the registered face images and the positions of the feature points, corresponding to the feature points, on the face of the collation face image. A collation portion 11 performs collation between the collation face image and each of the registered face images “1” to “N” by using the collation model of the database corresponding to the category selected by the category selection portion 10. The display portion 6 visually displays the category selected by the category selection portion 10, and visually displays the collation result of the collation portion 11.

Now, the reason why the face orientation estimation is necessary at the time of the collation will be described. (a) and (b) of FIG. 14 are views for explaining the reason why the face orientation estimation is necessary at the time of the collation, and show face orientations where the shape of the triangle indicating the eyes and mouth positions is the same between the right and the left or the upside and the downside. That is, (a) of the figure shows a triangle 57 of the face orientation (P degrees rightward) of the category “F”, and (b) of the figure shows a triangle 58 of the face orientation (P degrees leftward) of the category “G”. The triangles 57 and 58 are substantially the same in the shape indicating the eyes and mouth positions. Since face orientations where the shape of the triangle indicating the eyes and mouth positions is the same between the right and the left or the upside and the downside are present as described above, which category should be selected cannot be determined only based on the eyes and mouth position information of the collation face image. In the example shown in (a) and (b) of FIG. 14, a plurality of categories within the error D are present (the category “F” and the category “G”), and the face orientations of the categories are different as shown in the figure. If the category “F” of P degrees rightward is selected although the synthetic image is of P degrees leftward, collation performance deteriorates. Therefore, at the time of the collation, the category to be selected is determined by using both the eyes and mouth position information obtained by the eyes and mouth detection portion 8 and the face orientation information obtained by the face orientation estimation portion 9. The number of selected categories may be two or more, and when two or more categories are selected, the one with an excellent collation score is finally selected.

FIG. 15 is a view showing an example of the presentation screen of the result of the collation by the collation function of FIG. 13. On the screen shown in the figure, for the inputted collation face images 70-1 and 70-2, collation results 100-1 and 100-2 corresponding thereto, respectively, are displayed. In this case, in the collation results 100-1 and 100-2, the registered face images are displayed in decreasing order of score. It can be said that the higher the score is, the higher the probability of being the person concerned is. In the collation result 100-1, the score of the registered face image of ID:1 is 83, the score of the registered face image of ID:3 is 42, the score of the registered face image of ID:9 is 37, . . . Moreover, in the collation result 100-2, the score of the registered face image of ID:1 is 91, the score of the registered face image of ID:7 is 48, the score of the registered face image of ID:12 is 42, . . . On the screen shown in FIG. 15, in addition to the close button 92 for closing this screen, a scroll bar 93 for scrolling the screen up and down is set.

As described above, according to the object recognition device 1 of the present embodiment, the following are provided: the category selection portion 10 that selects a specific face orientation based on the error between the positions of the feature points (the eyes and the mouth) on the faces of, of a plurality of registered face images registered being categorized by face orientation, the registered face images and the positions of the feature points, corresponding to the feature points, on the face of the collation face image; and the collation portion 11 that collates the registered face images belonging to the face orientation selected by the category selection portion 10 and the collation face image with each other, the registered face images are categorized by face orientation range, and the face orientation range is determined based on the feature points; therefore, the collation face image and the registered face images can be more accurately collated with each other.

While face images are used in the object recognition device 1 according to the present embodiment, it is to be noted that images other than face images (for example, images of persons or vehicles) may be used.

(Summary of a Mode of the Present Disclosure)

An object recognition device of the present disclosure has: a selection portion that selects a specific object orientation based on an error between positions of feature points on objects of, of a plurality of registered object images registered being categorized by object orientation, the registered object images and a position of a feature point, corresponding to the feature point, on an object of a collation object image; and a collation portion that collates the registered object images belonging to the selected object orientation and the collation object image with each other, the registered object images are each categorized by object orientation range, and the object orientation range is determined based on the feature point.

According to the above-described structure, as an object orientation relationship such as a face orientation, that is, a positional relationship, one that is most suitable for the collation with the collation object image is selected; therefore, the collation object image and the registered object image can be more accurately collated with each other.

In the above-described structure, the error is calculated, when positions of at least three N (N is an integer not less than three) feature points are defined on the object for each object orientation and positions of predetermined two feature points of each object orientation and two feature points, corresponding to these two feature points, on the object of the collation object image are superposed on each other, by a displacement between positions of a remaining N−2 feature point of the N feature points and a remaining N−2 feature point, corresponding to the N−2 feature point, on the object of the collation object image.

According to the above-described structure, as the registered object images used for the collation with the collation object image, more suitable ones with which collation accuracy can be improved can be obtained.

In the above-described structure, the error is a pair of an angle difference and a line segment length difference between, of N−2 line segments connecting a midpoint of two feature point positions of the object orientation and the remaining N−2 feature points, the N−2 line segment of the object orientation of a collation model and a registered object image group and each N−2 line segment of the object orientation of a reference object image corresponding thereto.

According to the above-described structure, as the registered object images used for the collation with the collation object image, more suitable ones with which collation accuracy can be improved can be obtained.

In the above-described structure, an addition value or a maximum value of the errors between the N−2 feature points is set as a final error.

According to the above-described structure, collation accuracy can be improved.

In the above-described structure, a display portion is provided, and the object orientation range is displayed on the display portion.

According to the above-described structure, the object orientation range can be visually confirmed, and as the registered object images used for the collation with the collation object image, more suitable ones can be selected.

In the above-described structure, a plurality of object orientation ranges of different object orientations are displayed on the display portion, and an overlap of the object orientation ranges is displayed.

According to the above-described structure, the overlapping state of the object orientation ranges can be visually confirmed, and as the registered object images used for the collation with the collation object image, more suitable ones with which collation accuracy can be improved can be obtained.

An object recognition method of the present disclosure has: a selection step of selecting a specific object orientation based on an error between positions of feature points on objects of, of a plurality of registered object images registered being categorized by object orientation, the registered object images and a position of a feature point, corresponding to the feature points, on an object of a collation object image; and a collation step of collating the registered object images belonging to the selected object orientation and the collation object image, the registered object images are each categorized by object orientation range, and the object orientation range is determined based on the feature point.

According to the above-described method, as an object orientation relationship such as a face orientation, that is, a positional relationship, one that is most suitable for the collation with the collation object image is selected;

therefore, the collation object image and the registered object image can be more accurately collated with each other.

In the above-described method, the error is calculated, when positions of at least three N (N is an integer not less than three) feature points are defined on the object for each object orientation and positions of predetermined two feature points of each object orientation and two feature points, corresponding to these two feature points, on the object of the collation object image are superposed on each other, by a displacement between positions of a remaining N−2 feature point of the N feature points and a remaining N−2 feature point, corresponding to the N−2 feature point, on the object of the collation object image.

According to the above-described method, as the registered object images used for the collation with the collation object image, more suitable ones with which collation accuracy can be improved can be obtained.

In the above-described method, the error is a pair of an angle difference and a line segment length difference between, of N−2 line segments connecting a midpoint of two feature point positions of the object orientation and the remaining N−2 feature points, the N−2 line segment of the object orientation of a collation model and a registered object image group and each N−2 line segment of the object orientation of a reference object image corresponding thereto.

According to the above-described method, as the registered object images used for the collation with the collation object image, more suitable ones with which collation accuracy can be improved can be obtained.

In the above-described method, an addition value or a maximum value of the errors between the N−2 feature points is set as a final error.

According to the above-described method, collation accuracy can be improved.

In the above-described method, a display step of displaying the object orientation range on the display portion with respect to the display portion is further included.

According to the above-described method, the object orientation range can be visually confirmed, and as the registered object images used for the collation with the collation object image, more suitable ones can be selected.

In the above-described method, a plurality of object orientation ranges of different object orientations are displayed on the display portion, and an overlap of the object orientation ranges is displayed.

According to the above-described method, the overlapping state of the object orientation ranges can be visually confirmed, and as the registered object images used for the collation with the collation object image, more suitable ones with which collation accuracy can be improved can be obtained.

Moreover, while the present disclosure has been described in detail with reference to a specific embodiment, it is obvious to one of ordinary skill in the art that various changes and modifications may be added without departing from the spirit and scope of the present disclosure.

The present application is based upon Japanese Patent Application (Patent Application No. 2013-139945) filed on Jul. 3, 2013, the contents of which are incorporated herein by reference.

### INDUSTRIAL APPLICABILITY

The present disclosure has an advantage in that the collation object image and the registered object images can be more accurately collected with each other, and is applicable to a surveillance camera.

### DESCRIPTION OF REFERENCE NUMERALS AND SIGNS

1 Object recognition device
2 Face detection portion
3 Orientation face synthesis portion
4 Model learning portion
5-1, 5-2, . . . , 5-M Databases of the categories “1” to “M”
6 Display portion
8 Eyes and mouth detection portion
9 Face orientation estimation portion
10 Category selection portion
11 Collation portion

1. An object recognition device comprising:
a selection portion that selects a specific object orientation based on an error between positions of feature points on objects of registered object images which are registered and categorized by object orientation and a position of a feature point, corresponding to the feature point, on an object of a collation object image; and
a collation portion that collates the registered object images belonging to the selected object orientation and the collation object image with each other,
wherein the registered object images are each categorized by object orientation range and the object orientation range is determined based on the feature point.

2. The object recognition device according to claim 1, wherein the error is calculated, when positions of at least three N (N is an integer not less than three) feature points are defined on the object for each object orientation and positions of predetermined two feature points of each object orientation and two feature points, corresponding to the two feature points, on the object of the collation object image are superposed on each other, by a displacement between positions of a remaining N−2 feature point of the N feature points and a remaining N−2 feature point, corresponding to the N−2 feature point, on the object of the collation object image.

3. The object recognition device according to claim 1, wherein the error is a pair of an angle difference and a line segment length difference between, in N−2 line segments connecting a midpoint of two feature point positions of the object orientation and the remaining N−2 feature points, the N−2 line segment of the object orientation of a collation model and a registered object image group and each N−2 line segment of the object orientation of a reference object image corresponding thereto.

4. The object recognition device according to claim 2, wherein an addition value or a maximum value of the errors between the N−2 feature points is set as a final error.

5. The object recognition device according to claim 1, comprising a display portion,
wherein the object orientation range is displayed on the display portion.

6. The object recognition device according to claim 5,
wherein a plurality of object orientation ranges of different object orientations are displayed on the display portion, and
wherein an overlap of the object orientation ranges is displayed.

7. An object recognition method comprising:
a selection step of selecting a specific object orientation based on an error between positions of feature points on objects of registered object images which are registered and categorized by object orientation and a position of a feature point, corresponding to the feature points, on an object of a collation object image; and
a collation step of collating the registered object images belonging to the selected object orientation and the collation object image,
wherein the registered object images are each categorized by object orientation range and the object orientation range is determined based on the feature point.

8. The object recognition method according to claim 7, wherein the error is calculated, when positions of at least three N (N is an integer not less than three) feature points are defined on the object for each object orientation and positions of predetermined two feature points of each object orientation and two feature points, corresponding to the two feature points, on the object of the collation object image are superposed on each other, by a displacement between positions of a remaining N−2 feature point of the N feature points and a remaining N−2 feature point, corresponding to the N−2 feature point, on the object of the collation object image.

9. The object recognition method according to claim 7, wherein the error is a pair of an angle difference and a line segment length difference between, in N−2 line segments connecting a midpoint of two feature point positions of the object orientation and the remaining N−2 feature points, the N−2 line segment of the object orientation of a collation model and a registered object image group and each N−2 line segment of the object orientation of a reference object image corresponding thereto.

10. The object recognition method according to claim 8, wherein an addition value or a maximum value of the errors between the N−2 feature points is set as a final error.

11. The object recognition method according to claim 7, further comprising a display step of displaying the object orientation range on a display portion.

12. The object recognition method according to claim 11, wherein a plurality of object orientation ranges of different object orientations are displayed on the display portion, and
wherein an overlap of the object orientation ranges is displayed.
